(19) United States
(12) Patent Application Publication
(10) Pub. No.: US 2026/0236945 A1
(43) Pub. Date: Aug. 13, 2026

(54) SYSTEM AND METHOD FOR GENERATING PROCESS-VERIFIABLE DIGITAL CREDENTIALS

(71) Applicant: Peer Ledger Inc., Halifax (CA)

(72) Inventors: Dawn JUTLA, Halifax (CA); Peter BODORIK, Halifax (CA)

(21) Appl. No.: 19/537,772

(22) Filed: Feb. 12, 2026

Related U.S. Application Data
(60) Provisional application No. 63/757,848, filed on Feb. 13, 2025.

(51) Int. Cl. G06Q 30/018; H04L 9/32

(52) U.S. Cl. CPC G06Q 30/0185; H04L 9/32

(57) ABSTRACT

A system and method for the generation of process-verifiable digital credentials.

### CROSS-REFERENCE TO RELATED APPLICATION

This application claims the benefit of priority to U.S. Provisional Application No. 63/757,848, filed on 13 February 2025, the entirety of which is herein incorporated by reference.

### FIELD OF THE INVENTION

The present specification relates generally to traceability systems and digital credentials, and more particularly to a system and method for generating process-verifiable digital credentials.

### BACKGROUND OF THE INVENTION

Traceability systems may track a product's history and location at every stage of its lifecycle. It can be used to track a product's origin, manufacturing, storage, transportation, and delivery.

Furthermore, verifiability in a traceability system refers to the ability to independently confirm the accuracy and authenticity of recorded data within the system, ensuring that the information about a product's journey through the supply chain can be verified at any point, thus preventing potential manipulation or errors and providing high confidence in the traceability process.

And, verifiable digital credential (VDC) is a digital version of a document or attribute that can be verified using cryptography.

Further improvements to traceability systems with verifiability are required to improve the functioning of these systems. Accordingly, there remains a need for improvements in the art.

### SUMMARY OF THE INVENTION

In an aspect, the system and method enable automating collection of product and various digital credential information, including chemicals compliance information, associated with production of products and its components or materials for increased transparency and safety; and using this information in generating and managing trusted process-verifiable digital credentials with transparency for the data verification processes used. A process-verifiable digital credential is a verifiable digital credential that uses automated and/or non-automated processes to verify the data on the verifiable digital credential.

The digital information may be obtained from supply chain participants directly or via a blockchain-based supply chain traceability system or equivalent system with up-to-date information in potentially near real-time by keeping and verifying detailed information, including sustainability information (e.g. emissions, substances of concern) on the assembly and production processes at each step of a product’s supply chain. The result is a direct linking between production and compliance activities, and reduction or removal of the credential staleness issue. By keeping and recording detailed information on each input material or product being produced, a related credential and dependent or related credential reporting becomes verifiable with the result of increasing data accuracy, and it enables the producers, processors, buyers, and regulators to automatically obtain updated digital credentials and, in the case of the Safety Data Sheet (SDS) credential to know what regulated chemical substances are in the products they are producing, buying, and eventually selling to consumers.

The system and method employs a blockchain-based supply chain traceability platform that enables a feedback loop from upstream on the use of materials and product components so that it can be used to enhance the knowledge on the use of materials and products and better ensuring that the use satisfies the regulation and issue alerts on potential hazards on new uses of materials that were created using processes with secrets – the feedback loop enables the producers who use secrets to better monitor the use of their products to avoid unsafe downstream use of products created using known materials and secret substances. For instance, a secret production process may result in a product that contains unregulated chemicals that need not be reported, but that can lead to unsafe processes if combined with some other unanticipated products in some unanticipated uses. The presence and activities of the feedback loop can form another verifiable digital credential for the product.

The invention also stores, manages, and provides for search for regulations that apply to regulated materials, e.g. rules on the use, transport, and storage of regulated materials. The search mechanisms provide for specific searches using standard data management and retrieval techniques based on key searches. It may also provide for retrieval and anonymization of data on which AI techniques may be used while preventing information leakage.

Further, the system and method also provides for targeted provision of information to the various actors in the supply chain. This sharing of information is facilitated by creation of rules, enforced by a rule-engine, that specify which information is to be provided for which role in a manner that is similar to managing what is accessible to which role when a role-based access control system is in effect.

In an embodiment, the system and method may be used for creating a process-verifiable digital credential, the method comprising: processing a record comprising an input, a transformation, and an output; receiving an input digital credential for the input; verifying the data on the input digital credential; creating a verifiable input digital credential by cryptographically signing the input digital credential; creating the process-verifiable output digital credential containing the verifiable input digital credential by cryptographically signing the process verifiable output digital credential; and immutably recording the verifiable input digital credential and the process verifiable output digital credential to the record. In another embodiment, a verifiable digital credential may be received as input; the data on the verifiable digital credential is verified; if verified, it is used directly in the creating the process-verifiable output digital credential.

The method may further comprise: receiving an output digital credential for the output; verifying the output digital credential; creating a verifiable output digital credential by cryptographically signing the output digital credential; creating a process verifiable output digital credential containing the verifiable input digital credential and the verifiable output digital credential by cryptographically signing the process-verifiable output digital credential; immutably recording the verifiable input digital credential, the verifiable output digital credential, and, the process-verifiable output digital credential to the record.

The method may still further comprise: receiving a transformation digital credential for the transformation; verifying the transformation digital credential; creating a verifiable transformation digital credential by cryptographically signing the transformation digital credential; creating a process verifiable output digital credential containing the verifiable input digital credential, the verifiable output digital credential, and, the verifiable transformation digital credential by cryptographically signing the process verifiable output digital credential; immutably recording the verifiable input digital credential, the verifiable output digital credential, the verifiable transformation digital credential, and, the process verifiable output digital credential to the record.

The method of verifying of the input digital credential may comprise: validating an input attribute of the input with a stored input attribute in the input digital credential; and if the validating fails, then reporting an input discrepancy.

The method of verifying of the output digital credential may comprise: validating an output attribute of the output with a stored output attribute of the output digital credential; and if the validating fails, then reporting an output discrepancy.

The method of verifying of the transformation digital credential may comprise: validating a transformation attribute of the transformation with a stored transformation attribute of the transformation digital credential and if the validating fails, then reporting a transformation discrepancy.

The method of verifying of the digital credential may comprise: checking if the digital credential was previously verified; and if the digital credential was previously verified, then returning that the digital credential is a verified digital credential.

The method of verifying of the verifiable digital credential may comprise: checking if the data in the verifiable digital credential was previously verified; and if the verifiable digital credential was previously verified by reasonable processes, then returning that the verifiable digital credential is a process-verifiable digital credential.

In another embodiment, the input attribute is an input physical characteristic of the input; the output attribute is an output physical characteristic of the output; and/or the transform attribute is a physical transformation of the transformation.

In an alternative, the input attribute is an input identity of an input party related to the input; the output attribute is an output identity of an output party related to the output; and/or the transformation attribute is a transformation identity of a transformation party related to the transformation.

In another alternative, the input attribute is an input permission for the input; the output attribute is an output permission for the output; and/or the transform attribute is a transform permission for the transformation. A permission may be, for example, a license to produce an amount of medication or controlled substance, a license to use an amount of a controlled substance as an input in the creation of an output, a license or certification to dispose of an amount of hazardous waste or disposing according to a specific transformation of the hazardous waste, an environmental certification for the input, transformation, or output, etc.

In the method, the attribute may comprise multiple attributes of physical characteristic, identity, and/or permission for each of the input, the output, and/or the transformation for the record.

The method of validating of the attribute may comprise: sending the input digital credential, the output digital credential, or the transform digital credential to an issuer of the digital credential or a verifier for verifying the digital credential; receiving a valid digital credential response or an invalid digital credential response from the verifier; and if the valid digital credential response is received from the verifier, then validating the attribute.

The method may further comprise: tracing the record by using the process verifiable output digital credential, the tracing comprising: extracting from the process verifiable output digital credential the verifiable digital credentials; determining if the verifiable digital credentials match the input, the output, and/or, the transformation; if the verifiable digital credentials do not match, then returning that the verifiable digital credentials do not match; if the verifiable digital credentials do match, the returning that the verifiable credentials do match.

The method may further repeat the tracing of the record by tracing a linked record, the linked record being related to the input, the output, and/or the transformation with a linked process verifiable output digital credential.

The method may further comprise: searching the record for a search object by the tracing further comprising: determining if the search object matches or is contained by the record or the process verifiable output digital credential; if the search object matches, then returning a search match; if the search object does not match, then continuing the searching for the linked record; wherein, the search object is one or more of the input, the output, the transformation, the party, the digital credential, or the attribute.

The method may further comprise: sending the process verifiable output digital credential to the verifier for verification and cryptographic signing of the process verifiable output digital credential by the verifier.

In still another embodiment, the method may further comprise: where the verifying of the input/output/transformation digital credential determines that the input/output/transformation digital credential is non-verifiable; the creating a process-verifiable output digital credential containing the verifiable input/output/transformation digital credential by cryptographically signing the process verifiable output digital credential, further comprising: creating the process verifiable output digital credential containing the non-verifiable input/output/transformation credential by cryptographically signing the process verifiable output digital credential, and, marking the process verifiable output digital credential as containing a non-verifiable credential; and/or creating the process verifiable output digital credential containing the non-verifiable input/output/transformation credential and the verifiable input/output/transformation digital credential by cryptographically signing the process verifiable output digital credential, and, marking the process verifiable output digital credential as containing a non-verifiable credential;

In the method, cryptographically signing may comprise hashing and cryptographically signing.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a block diagram illustrating different types of verified digital credentials;

FIG. 2 is a block diagram of the data flows for credential creation;

FIG. 3 is a block diagram of the system components;

Like reference numerals indicated like or corresponding elements in the drawings.

### BRIEF DESCRIPTION OF THE APPENDIX

U.S. Patent No. 11,461,775, which issued on 4 October 2022 and is titled "System and Method for Tracking Provenance and Flows of Goods, Services, and Payments", is hereby incorporated by reference in its entirety for all purposes, including its disclosure of a blockchain-based traceability system that can be leveraged and enhanced.

### DETAILED DESCRIPTION OF THE EMBODIMENTS

Verifiable digital credentials are digital credentials that have been cryptographically signed to assure the digital credential itself has not been tampered with and to identify the credential issuer and/or holder, among other attributes. Verifiable digital credentials in the current state-of-the-art do not have associated verification processes around any product data that may be the subject of the credential. Verification may be proof of conformance to standards and processes etc. Validation refers to whether the system or object etc. provides the benefits it touts to users.

Trust in online data, and by extension credentials, about products is difficult to foster. One example, the EU’s SCIP (Substances of very high Concern in Products) digital database, existing as a single repository system, attempts to provide transparency into product make-up and ingredients to increase consumer’s awareness and trust in the safety of well-regulated EU products. It allows consumers globally to search for substances of concern in products and their components as sold in the EU market to understand this aspect of a product’s sustainability profile, i.e. the product’s impact to human or environmental health. However, SCIP does not connect to other systems, such as supply chain traceability systems to verify the product information submitted to it. Further, SCIP does not provide product sustainability information beyond substances of concern, such as the recyclability of the products in various jurisdictions. Without connection to a digital supply chain traceability system, product claims are not digitally verifiable on demand. Commonly, product claims which contribute to a product’s digital credentials, and which may be digitized, are produced statically, sometimes once a year, or once every few years, and are sometimes verified by a third-party auditor and sometimes not verified at all.

For products, cryptographically signing unverified or bad data on a verifiable digital credential is possible today and thus some purportedly verifiable digital credentials (VDCs) fail to foster digital trust. Like all other digital systems, cryptographically signed data on blockchain suffers from the classic garbage-in, garbage-out issue. Existing traditional supply chain traceability systems, in theory, are to provide trusted tamper-proof verifiable digital credentials, but the reality is that most existing traceability systems used in firms today collect data by surveys or smart questioning or from API-based integrations of data from existing systems where data verifications happen on sampled products, not all products, and only a few times per year.

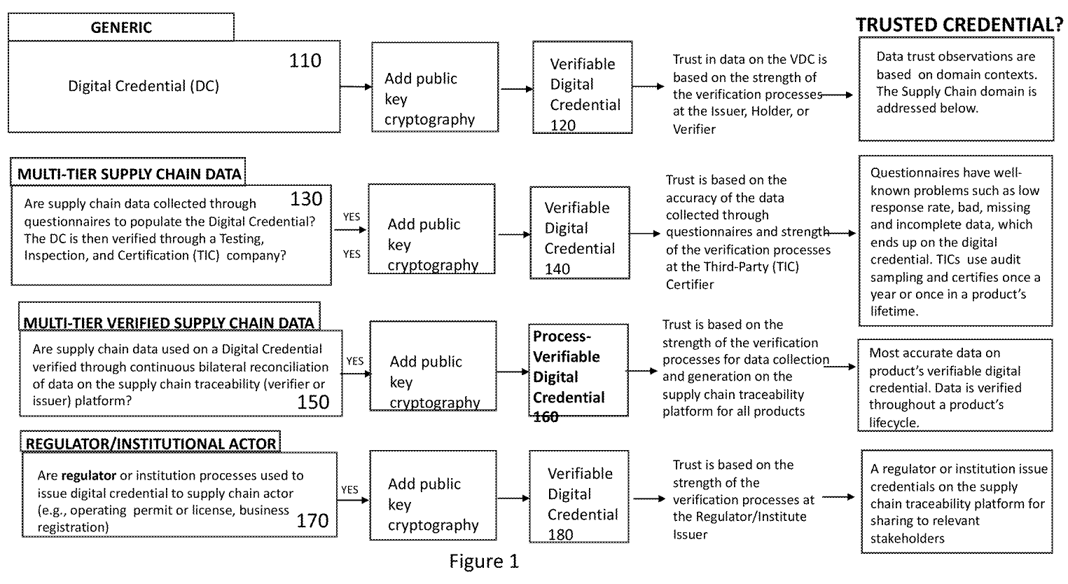

Furthermore, the data in ERP systems often need to be cleaned due to bad, incomplete, and missing data. Corporations spend tens of millions of dollars each year fixing data. Clearly, cryptographically signing potentially bad, missing, or incomplete data makes for an untrusted verifiable digital credential in most of these systems. There is a need for supply chain traceability systems to perform verification on the data as it is collected by systems and methods of traceability and verification. An example traceability system is described in U.S. Patent No. 11,461,775 (incorporated by reference). The systems and methods should also execute and perform continuous verification of data. Other methods for verification exist in the state of the art that do point-in-time verification of data, e.g. once or twice a year, such as those methods employed by testing, inspection, and certification (TIC) companies on samples of company data. With continuous or sampling-based processes for verification on their data, the traceability origin and supply chain journey data on blockchain-based supply chain traceability platforms are equally termed verifiable, but trust in them differs from a continuous verification system. See FIG. 1 for illustration. For data on digital credentials from a supply chain traceability system to be accurate and truly verifiable then processes that do continuous verification of product data are needed to form process-verifiable digital credentials (PVDCs).

In general, product credentials can take various forms. For example, organizations report information on their products, as they relate to the product’s content of regulated materials as ingredients or as inputs/output of the production processes, in Safety Data Sheets (SDSs). Thus, a digitized SDS may be considered an example of one of a product’s digital credentials. SDSs are generated occasionally – sometimes once a year or once every few years. SDSs in use commonly lack data and are sometimes outdated. Supply chains use traceability systems that receive and store information from the supply-chain actors on creation and use of substances in products, including provision of (copies of) SDSs on their products. However, as formulations change or new regulated substances are created or new regulations arise or are updated, in the current state-of-the-art SDS credential information becomes outdated or incomplete over time, and incorrect information is then frequently employed on use and management of regulated products.

Productions, uses, transportation, disposal, and storage of some substances/materials/goods are regulated by policies, rules and standards issued by various standards organizations or various levels of government. When a new substance or material, such as for use in a household cleaner, is produced, it is registered in a trusted expert repository such as the Chemical Abstract Services Center, a division of American Chemical Society. In turn, the composition of a product such as a household cleaner, in terms of its CASes, is declared by the producer, and may or may not be third-party certified, to meet applicable regulations in terms of the content of any regulated substances. Similarly, when a new product is assembled that uses any parts that may contain regulated substances or materials, then the composition of the product/material must be declared on Safety Data Sheets (SDSs). The producer records, in an SDS for an item, ingredients input into the production process for that item and for each ingredient it also states the content within the item using one or more of the hundreds of appropriate units, such as grams, milliliters, or percentages that are used to express the content of the substance or material within an item that SDS describes. This safety data sheet is submitted to the buyers and regulator(s) and is also recorded in a searchable DB of safety data sheets, such as United Laboratories’ SDS database.

Another problem for verification of a product’s digital credential for sustainability, such as a digital SDS, is that there is separation of duties for collection, management, and use of data by production information systems and compliance at each supply chain entity, thereby resulting in compliance employees and their systems not having visibility into production systems and vice versa. This problem is complicated by the dependencies on the upstream to provide timely and complete product substances information across supply chain tiers. As a result, bad data creeps into the traceability systems. Further, it has been observed that existing databases contain aged entries still in use and that subsets of them are not updated regularly and are inaccurate. The result is that currently retailers may have no good way of knowing what chemicals are in the products they sell to consumers.

Further compliance may be difficult to ascertain, especially when credentials need to be aggregated. Continuing the SDS credential example, when a product or material is being produced by an assembly of parts with or without any synthesis of materials, a static SDS credential of the product may be derived by digitally aggregating information appearing in the SDSs of the parts used in its assembly. The problem is that if any of the static SDS of the parts used in the assembly are inaccurate, then the digital SDS of the product produced by the assembly is also inaccurate.

This system specifically deals with process-verifiable digital credentials (PVDC) dependent on the management of a product’s sustainability information by different product stakeholders, information about production of substances, materials, and products and as such clarification is given herein on the terminology used in this document. In an embodiment, the PVDC comprises data-verified VDCs related to the product’s input, the output and/or the transformation of the input into the output. In another embodiment, the PVDC may also comprise the corresponding record in the traceability system to recursively and/or repeatedly trace and verify the input, the output and/or the transformation. The words substance, material, product, and product content are used in this application in the following way.

Substance is used to refer to “physical material from which something is made or which has discrete existence”. A substance is homogeneous, and in this application it is used to primarily refer to chemical substances.

Material is used to refer to “the basic elements from which something can be developed” and, in thisapplication it may be used to include substance, but in general, a substance might not refer to material. For instance, cloth is a sewing material, but it would not be referred to as a substance.

Product is used to refer to “something produced by physical … effort”. A product is used to refer to an item that is sold to a client. In this context, however, a product could be sold to a client that uses it as input, for instance as an assembly part or as material or substance used in production of a part, into a process that produces some other product. As a supply chain track and trace software is used to track not only the products in the supply chain, but also on their properties that include information about the use of substances, materials, and products, such as ingredients/products used as input to the production process, content of a product in terms of its ingredients and other properties. In this document, which deals with tracking information about products in a supply chain, the term product may be used to describe any of a substance, a material, a part used as inputs in production of further products, or an end-user product.

Product composition or content is used to describe ingredients of a product in terms of substances, material, and/or parts used as input to the production process of a product. It thus may describe chemical substances that the product contains within it or it may also describe substances/materials/products from which are used as input or ingredients into the process that generates the product. For some products, their composition is known and can be expressed in absolute terms, such as how many and which parts are used in an assembly process. However, for some products, such as chemical substances, the content of some of the ingredients is not described in absolute terms, but rather using ranges. For instance, the product X (e.g. perfume) is such that 1 to 2 percent of its content is ingredient Y. It should be noted that there are many units that can be used to describe the composition of a product, depending on the type of substance, material, or product.

The term secret is used herein to describe a production process for some product, such as perfume. The production process for a product describes inputs into the process, inputs that include products as input that are fully or partially consumed by the process, e.g., as process catalysts. How much of an input-product is consumed and how much is retained within the produced product is also described. If the production process is not disclosed, but it is kept private and not intended for disclosure so that the competitors are unable to replicate it, is referred as a secret herein. For instance, perfume is a substance that may have a secret that is used in its production process.

Production of substances, materials or items/products is regulated by rules and standards issued by governments at various levels or standards organizations, rules that govern the use of certain substances or materials that are also referred to as regulated substances or materials. When a new product, substance or material is produced that contains regulated chemicals or materials, its composition, in terms of how much of each regulated and non-regulated substance of concern/material of concern/product of concern/product component of concern is contained within it and how much is used-up or produced by the production process, is recorded in a verifiable digital credential for the product and elsewhere in the new product introduction to a market. At minimum, a producer might include information on any regulated substances or materials that the product contains in a verifiable digital credential.

Similarly, when a new product is assembled that uses any parts that may contain regulated materials, the composition of the product/material may be placed in one or more (process)-verifiable digital credential(s). A verifiable digital credential may list each regulated or non-regulated substance of concern/material of concern/product of concern/product component of concern contained and how much of it using appropriate units, such as grams, milliliters, or percentages. A product’s verifiable digital credential(s) and other specific regulatory information may be submitted to the regulator(s), supply chain stakeholders, and/or customers on new product introduction in a jurisdiction and at other times on request. Furthermore, any newly produced product/material that may contain regulated substances or ingredients may be selected, e.g. on a random basis, and submitted for testing by a Test Center that analyzes the material and certifies the materials composition as recorded by the material’s verifiable digital credential. This invention’s process-verifiable digital credential is updatable by append-only method, if the test results do not match the previous attributes in the credential, the test event and its attributes can be appended as a correction.

(Process)-verifiable digital credentials for products may also be derived. For example, when a new product or material is being produced by an assembly of parts without any synthesis of materials, the (process)-verifiable digital credential(s) for the product may be derived by aggregating information appearing in the (process)-verifiable digital credential(s) of the parts used in its assembly. The problem is that if any of the (process)-verifiable digital credential(s) for any part used in the assembly are inaccurate, then the (process)-verifiable digital credential(s) of the product produced by the assembly is also inaccurate. Therefore, methods for obtaining accurate data through verification (validation) and traceability, are necessary to have accurate derivations of (process)-verifiable digital credentials for products. It has been observed that many existing product credentials, such as safety data sheets, and recycling claims contain aged data and cascaded inaccuracies. The result is that retailers do not know which chemicals are in the products nor the sustainability profile of the products they sell to consumers.

Starting with the embedding of reconciliation processes in the collection and organization of (compliance) information associated with the production of new materials or products in extended supply chains, the present system and method then leverages this data and collects new data that together (1) assure various properties such as ingredient accuracy, substitutability, and sustainability as well as their verifiability and information display; and (2) using this information in creating and managing process verifiable digital credentials (PVDCs). For products, an example PVDC can be a new SDS generated after a formula change with up-to-date information. By recording and making visible the detailed event information on each input material or product being produced (output), the PVDC and dependent or related reporting becomes process-verifiable, and it could enable an entire ecosystem of producers, processors, distributors, retailers, and regulators to automatically obtain up-to-date process-verifiable digital credentials and other reporting. In an embodiment, the PVDC is linked to the product (output), linked to the input, and/or linked to the transformation as part of the product and process.

A process-verifiable digital credential can be re-issued repeatably as the ingredient formula or other attribute of a product changes. Multiple process-verifiable credentials of the same type can co-exist for the same product - for example for different batch numbers or serial numbers or time periods. Specific PVDCs may be searched for, to find or identify a compromised credential, or for other information (attributes).

When a new product is produced, information about the materials or parts input to the process are recorded, together with a description of the process (transformation), parts and materials produced (output), parts and materials consumed in the production process (input and/or transformation), and whether secret(s) are used, wherein only the existence of the secret is recorded, but not what it is (i.e. the secret is not disclosed, yet its existence is. Companies may opt to store the secret using a provably secure method). Enterprise Resources Planning (ERP) and traceability systems that are capable of collecting production information exist but are not yet used for collection, verification, and/or use of the collected regulated information as described by this invention. Furthermore, even if information described herein is collected from producers and processors, it is not used to obtain up-to-date and accurate information on the content of regulated materials in products, or on how products with secrets are used in production processes by producers, on demand.

The blockchain-based traceability system (an embodiment is described in in U.S. Patent No. 11,461,775 (incorporated herein by reference)) is augmented with information that is collected about a production process includes information on whether the process itself consumes or generates any materials, together with error margins for production or consumption and retention of materials (e.g., the process may consume X% of the regulated input material, with a margin of error of +/-Y%, or that the produced material/product contains X% of regulated material with a margin of error of +/-Y% to indicate that the produced materials may contain X% of the regulated material input to the process plus/minus Y% in variation that is still considered normal.) This information is recorded, stored, managed, and used by a track and trace system that is used to collect, record, store, and manage the supply-chain information. It also provides for search of the collected data for various purposes, such as AI analysis of the production and use of materials and parts in supply chains.

The recording of inputs, outputs, and consumption and production of materials or parts in the production process is used in a method to compare information, as observed and recorded for the process and its materials, parts or products that were input, output, produced or consumed (transformed), to the corresponding information stored in the system and recorded in a repository. Each record is thus linked to the input, the output, the transformation and the traceability of the product. In case of discrepancies that are outside the normal ranges that would be expected for information as recorded in this repository, alerts are raised that describe where the discrepancies are and what they are, so that they may be checked. Potentially, the discrepancies may be used for raising concerns on potentially dangerous storage, transport, or use of chemicals or products.

Also, the system enables a feedback loop among distant actors in the upstream and downstream on the use of materials and products. This loop can be used to enhance the knowledge on the use of materials and products to better ensure that the use satisfies the regulation and issue alerts on potential hazards on new uses of materials that were created using processes with secrets. The feedback loop enables the producers who use secrets to better monitor the use of their products to avoid unsafe use of products created using secrets. For instance, a secret production process may result in a substance that contains unregulated chemicals that need not be reported, but that can lead to unsafe processes if combined with some other unanticipated products in some unanticipated uses. The invention also stores, manages, and provides for searches on specific information regulations as they simultaneously or serially apply to regulated materials across contexts, e.g. rules on the use, transport, and storage of regulated materials. Further, this invention also provides for targeted provision of information to the various actors in the supply chain. This is enabled by creation of rules or permission that specify which information is to be provided for which role in a manner that is similar to managing what is accessible to which role when role-based access control system is in effect.

The following example describes the system and methods for collection of detailed information about production of new goods, such as materials, chemicals or products and their use for various purposes. The collected information also includes, amongst others, information on (i) if secrets were used in the production of a new substance, material, or product and (ii) uses of the materials or products.

FIG. 1 shows the distinctions between verifiable digital credentials and process-verifiable digital credentials. Verifiable digital credentials are created after applying public key cryptography and cryptographic hashing (or cryptographic hashing and signing) to a digital credential. Public key cryptography and cryptographing hashing ensures the tamper-proofing of the document as well as verifies who issued the credential and the holder of the credential. Process-verifiable digital credentials assure the data on the credentials have been verified within the data collection process and the description and results of the processes used for data verification are continuously available, i.e. available on demand in near real time.

A generic Digital Credential 110 (DC) may be converted into a Verifiable Digital Credential 120 (VDC) by the addition of public key cryptography to the DC. The level of trust in the data on the VDC 120 is then based on the strength of the verification processes of the Issuer, Holder or Verifier.

A supply chain Digital Credential 130 (DC) may be generated from supply chain data collected through questionnaires and verified through a Testing, Inspection and Certification (TIC) company. The DC 130 may then be converted into a Verifiable Digital Credential 140 (VDC) by the addition of public key cryptography to the DC. The level of trust in the data on the VDC 140 is then based on the accuracy of the data collected through the questionnaires and the strength of the verification processes of the TIC.

A process-verified Digital Credential may be generated where supply chain data used in the DC 150 are verified through continuous bilateral reconciliation of data on the supply chain traceability (verifier or issuer) platform. The DC may be converted into a Verifiable Digital Credential (VDC) by the addition of public key cryptography to the DC. This process may include hashing and cryptographically signing the digital credential. In an embodiment, then the PVDC (160) is created from the verification of the input VDC, optionally a transformation VDC, and/or output VDC. The PVDC may also contain VDC and/or non-verifiable digital credentials. In an embodiment, the non-verifiable digital credentials are treated programmatically like the VDC along with a flag that the non-verifiable digital credential is included. It is understood that not every credential or digital credential will be or become verifiable. In an embodiment, a non-verifiable digital credential may raise a discrepancy. In another embodiment, the verifying a digital credential or VDC is checking that the cryptographic hashing and cryptographic signing are valid. Where the digital credential cannot be verified or fails verification, e.g. a lack of cryptographic signature or invalid signature, or the data on the credential fails verification, then the digital credential is marked or flagged as non-verified. The level of trust in the data on the PVDC 160 is then based on the strength of the verification processes for data collection and generation on the supply chain traceability platform for all products.

A regulator Digital Credential 170 (DC) may be issued by a regulator or an institutional process to a supply chain actor, examples include operating permits or license, or a business registration. The DC 170 may be converted into a Verifiable Digital Credential 180 (VDC) by the addition of public key cryptography to the DC. The level of trust in the data on the VDC 120 is then based on the strength of the verification processes of the Regulator/Institutional Issuer.

A regulator may further issue a trusted (process)-verifiable digital credential to a supply chain traceability platform. The regulator-issued-VDC can then be made available to supply chain participants to foster trust.

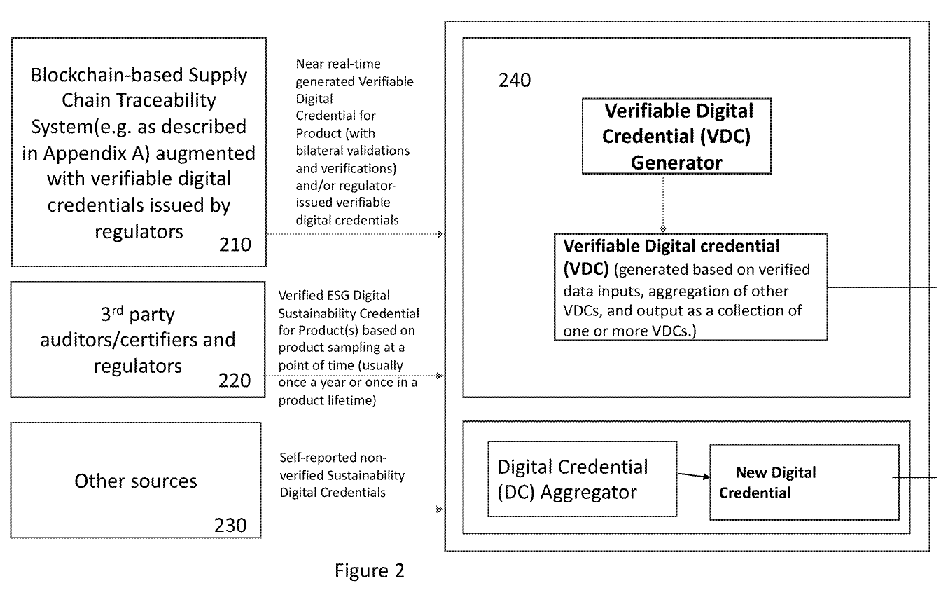

It is predicted that regulators will issue verifiable digital credentials, such as permits to organizations to operate legally as a supply chain actor in a particular domain, onto blockchain-based supply chain platforms. These regulator-issued VDCs, as well as other VDCs composed of supply-chain data (e.g. verifiable supply chain traces) will be processed by a Verifiable Digital Credential Generator as shown in FIG. 2. The Generator can act as a pass-through, as a cryptographic signer or hasher, or as an aggregator of input VDCs that will output a single VDC or multiple VDCs depending on purposes and use cases. The system will also obtain non-verified digital credentials, from digital credentials, that are marked as non-verifiable or flagged as non-verifiable. These non-verifiable digital credentials may be aggregated or passed-through to increase trust also. In an embodiment, this aggregation of input VDCs that will output a single VDC or multiple VDCs that will be hashed and signed into a PVDC. That is, in an embodiment, a process verifiable digital credential generator.

The first input 210 comprises records from the traceability system are augmented with verifiable digital credentials issued by regulators. These records may include near real-time generated verifiable digital credentials for the product, with bilateral validation and verification, and/or regulator-issued verifiable digital credentials. A second input 220 is sourced from third party auditors, certifiers and/or regulators. These records may include a Statically Verified ESG Digital Sustainability Credential for the product (in an embodiment, a permission). A third input 230 comes from other sources, and the records may include self-reported non-verified Sustainability Digital Credentials.

The Verifiable Digital Credential (VDC) Generator 240 then generates a process-verifiable digital credential (PVDC) based on the verified data inputs 210 and the aggregation of other VDCs (from second input 220) to output a new PVDC as a collection of one or more VDCs are collected from the inputs, along with the verification process and information for the verifiable digital credentials. The Digital Credential (DC) aggregates the non-verified digital credentials (from third input 230) into a new digital credential (DC) as a collection of one or more DCs.

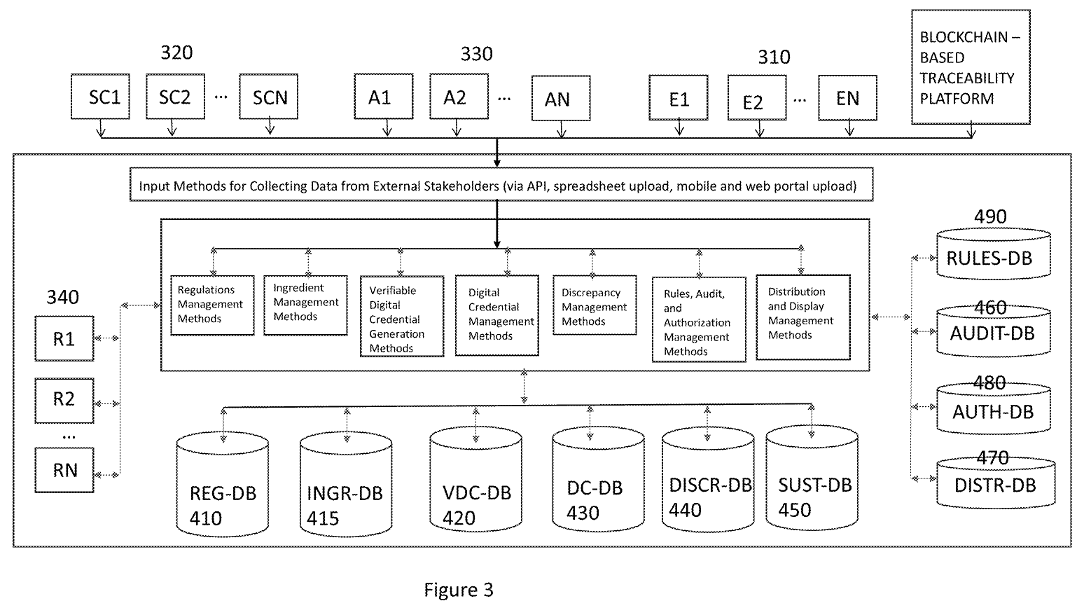

FIG. 3 shows the major components of the system, the entities within a supply chain who may directly input to the system, and input from a blockchain-based traceability platform 305. Within the system, it is to be understood that the terms database and repository may be used interchangeably. In an embodiment, the method and system adds verification processes for data on VDCs and VCs, and outputs PVDCs. That is, the data on PVDCs are already verified whereas its possible they are not on VDCs or DCs.

Entities 310 within the supply chain labeled as E-1, E-2, …, E-NE, where E-NE is the number of entities in the supply chain. It is these entities within the supply chain from which the systems collects all information provided by any of the supply-chain entities. Entities 310 are either producers and suppliers of materials, parts or products, or consumers of such materials and products, or both as an entity may be a consumer of certain materials or parts to produce other materials or parts that are supplied to the downstream entities. Note that E1, E2..EN may also be simultaneously participating on the blockchain-based traceability platform.

Each entity E-i needs to provide verifiable digital credentials for each product it produces that contains regulated material/substance – an example of a verifiable digital credential is a digital SDS for a regulated material that can be produced by this invention’s system. As an SDS can be re-issued repeatably as the formula for a product changes, multiple verifiable credentials of the same type for the same product are issued for different batch numbers or serial numbers or time periods.

An entity may be a company or organization, or it can be an organizational part of a company, such as a division or a department or business unit. An entity, however, participates in the supply chain by communicating, as described in this application, with the described system for the purposes of informing the system about product properties, such as its chemical substances and ingredients and ratios of these; and general sustainability properties such as recyclability.

Services centers 320 labelled as SC-i, i = 1, 2, …, SCn, provide search services, such as finding identifiers of substances that contain chemicals or substances that are passed as parameters. Herein, it is to be understood, whenever there is a reference to one of the SC centers, then information also identifies which of the Service centers it is. Furthermore, information obtained from any of the service centers SC-i is stored in the system’s various repositories and the system keeps track of which chemicals, regulations, or credentials, stored in the INGR-DB (Ingredients Database), REG-DB, and VDC-DB or DC-DB respectively, have been retrieved from which of the service centers.

An instantiation of a Service center, e.g. SC-1, may be the Chemical Abstract Service that “… is a periodical index that provides numerous tools such as SciFinder as well as tagged keywords, summaries, indexes of disclosures, and structures of compounds in recently published scientific documents … The two principal databases that support the different products are CAplus and Registry … Registry contains information on more than 130 million organic and inorganic substances and more than 64 million protein and nucleic acid sequences.”. SC-1 uses the SC index, also referred to as a SC identifier or SC number, that is used to identify uniquely individual substances. The SC-1 service includes methods to find information about a substance, given the SC index of the substance. Pubchem is another example of a public trusted chemicals database.

As there may be other organizations, e.g., in the same or different parts of the world to where the SC-1 Center is located, that provide services equivalent to those of the SC-1 Center. FIG. 1 shows additional centers (e.g. regulators) that provide services equivalent to those of the SC-1 center, but perhaps using a different language and different standard for unique IDs. The system connects and retrieves information from each of the centers, SC-i, as is required. When the supply-chain entities are reporting their activities on products to the system and the reporting information refers to a credential or document that is stored in a SC-j, then the system records that information in its repositories.

Searchable repositories/databases 340, labelled as R-1, R-2, …, RnR, where RnR is the number of such repositories. The system communicates, using either a push or a pull approach described later, with the repositories to retrieve regulations about products across jurisdictions in supply chains. The regulations are used by the system to ensure that the producers of products satisfy applicable regulations on the products and can provide information and/or references to such applicable regulations to actors whenever they are performing actions on products.

Auditors 330, labeled as A-1, A-2, …, AnA, that receive reports from the system on any issues, such an inconsistencies arising about products or their components anywhere in the supply chain. Auditors have the authority to view certain information provided by the system, information that they require to ascertain that the supply-chain entities do follow all regulations when producing, transporting, storing, and disposing regulated substance, material or products. Inconsistencies or discrepancies detected by the system are reported to the auditors and to the producers of products or credentials that give rise to the inconsistencies. In addition, the system provides auditors with periodic reports on the supply chain status and on issues found in the data received from the supply-chain entities. In addition to the periodic reports, the system also provides the entities and the auditors with a dashboard providing useful information. Moreover, the system supports privacy in that dashboards, reports, and search results only provide information such that the authenticated viewers only view information that they are permitted to see.

As the supply-chain entities have physical locations as do the Service Centers SC-i, i = 1, 2, …, CnC, and the regulation repositories R-j, j = 1, 2, …, RnR, each of the supply-chain entities needs to be concerned primarily with the Service Center and the regulations repository that services the geographical location in which the supply-chain entity is located. Consequently, by default, the Service Center that needs to be accessed by the supply-chain entity is the one located in the same geographical region in which the Service Center is located. For instance, for the supply-chain entities located in North America, by default the Service Center that is used to store or search for the SDSes chemical substances is SC-1, the Chemical Abstract Service Center.

Similar statements apply to the regulations’ repositories. If a supply-chain entity is located in the geographical place X, then regulations applicable to the products produced in X must adhere to regulations that are applicable to X. However, there could be more than one regulations’ repository applicable to a geographical region as for one geographical location X, for instance: (i) regulations made by the country’s government agencies apply, (ii) as do the regulations made by a state/province in which X is located, (iii) as do the regulations of a municipal government; (iv) as do regulations made by an association to which an organization belongs. or (v) regulations from different government agencies such as those dealing with health and the environment. However, each supply-chain entity, as well as the system, know which regulations repositories need to be consulted for products produced in X.

As a consequence of the above, a statement that entity E-i, located in X, submits a new substance to the SC-i service center, it is assumed that the new substance is submitted to the SC-i center serving the location X. Similarly, a statement that a supply-chain entity conforms to the regulations contained in a repository R-i, it is assumed that R-i is a repository/DB of regulations that are applicable to the location where the product is produced as well as the regulations of the repository applicable to the location where the product currently is located.

Regulatory Database 410, labeled as REG-DB, contains information on regulations applicable for transport, storage, and use of regulated materials. The REG-DB includes information on the regulations and on which products within the supply-chain they apply. REG-DB contains information obtained from the regulation repositories R-1, R-2, …, RnR. Regulations may be of various types applying to a product. There may be a regulation stating for a particular regulated product, e.g., substance X, how much of that regulated product may be contained in any product that uses X as input. For instance, it may state that any product may not contain more of the product X than Z percentage of the volume, or it may use one of the many units that may be used for such a purpose. Regulations may apply to transport of a product, such as the substance X may only be transferred in volumes less than Z, or that X must be transported in specific containers with specifications, such as the container must be made from alloy Y that is at least 2 mm in thickness. Regulations may apply to the use of the product, for instance it may state that a product X may be used only for the production of the product Y, or they may apply to the storage or disposal of a product.

Regulations also include conditions on applicability, for instance based on dates (When is the regulation in effect?), geographical region/country (To which geographical region does the regulation apply?). Information stored in the REG-DB is obtained from the sources of regulations (repositories R1, R2, …, RnR) and is kept up to date as described herein.

Verifiable Digital Credential Database 420, labeled as VDC-DB, that contains verifiable digital credentials generated by the system or as collected from external sources. The database VDC-DB is used to store information on verifiable credentials that are obtained from organizations and/or repositories. When a supply-chain entity provides to the system information on a material or a product for the first time, the system connects to subscribed or public sources and obtains verifiable credentials for each of the product’s ingredients and for the product itself and stores them it in its VDC-DB repository. As described before, the system uses a pull or push approach to keep the VDC-DB up to date. In an embodiment, there is a process verifiable digital credential (PVDC) database (not shown). In another embodiment, the PVDC database is part of the VDC database 420. In another embodiment, the PVDC are stored in the VDC database.

Digital Credential Database 430, labeled as DC-DB, that contains digital credentials uploaded to the invention. The database DC-DB is used to store information on credentials that are obtained from organizations and/or repositories. When a supply-chain entity provides to the system information on a material or a product for the first time, the system connects to subscribed or public sources and obtains digital credentials for each of the product’s ingredients and for the product itself and stores them it in its DC-DB repository. As described before, the system uses a pull or push approach to keep the DC-DB up to date.

Discrepancies Database 440, labeled as DISCR-DB, that contains information on discrepancies between the information reported by the supply-chain entities and previously reported information as reported to the SC Center or as previously reported to the STAT system. For instance, if the production process for product X implies that X contains Z percent of its volume as substance Y, but the SDS for the product X, as reported to the SC Center, is W, where Z > W, then there is a discrepancy if the production process for X does not consume the ingredient Y. The discrepancy is stored in the DISCR-DB and it is used in alerts to actors and, potentially, regulators.

The DISCR-DB further contains information on inconsistencies, also referred to as discrepancies, between the information contained in the VDC-DB, DC-DB, and the SUST-DB or between the previous reports on the production, storage, transport, reuse, repair, resale, recycling, and disposal of a product and information being currently reported. Detection of inconsistencies/discrepancies is performed by the methods that are described below.

In addition to the information stored in the DISCR-DB on inconsistencies that were detected, the database also contains information on alerts and reports that were sent to the supply-chain entities and the auditors informing them about the found inconsistencies/discrepancies.

Sustainability Database 450, labelled as SUST-DB, that contains all information that the system’s methods the receive from the supply-chain entities about their products and operations on them, such as transforming, transporting, or storing, their chemicals of concern, product marks and symbols for multiple purposes (e.g., differentiated information, recyclability), and instructions for safety, recyclability, or repair. The database SUST-DB contains any information collected from entities within a supply chain, information not only on regulated substances and materials, but any information provided by the supply chain entities on the product’s carbon emissions, production, transport, storage and use of substance/material/product, regardless of whether that substance/material/product is regulated. A substance or material may be regulated in one geographical region, while it may not be regulated in another – the system records and stores all information provided by the supply chain entities, regardless of whether that information is on regulated material or not in a particular geographical region.

SUST-DB contains the most up-to-date information about any substance, material, or product that any producer (entity) in the supply chain makes. Any information obtained from an entity about a product is compared to the information stored in the VDC-DB, DC-DB and in the SUST-DB and any discrepancies, between the observed information and that stored in the VDC-DB OR DC-DB, that are more than allowable threshold values for that product, the methods store information about the discrepancies in the DISCR-DB and raise alerts that indicate need for checking the reasons for discrepancies/inconsistencies and for the resolution of those discrepancies. This process is described in the following section that describes the methods. Thus, the SUST-DB contains for each product two types of information: (1) Most up to date information provided to the system by the supply-chain entities and (2) References to the discrepancies, stored in the DISCR-DB, between information stored in the SUST-DB, which was reported on the product to the system by a supply-chain entity and information stored in the VDC-DB OR DC-DB and the SUST-DB on the product’s ingredients.

Audit Database 460, labeled AUDIT-DB that has information on reports, audits, and supply-chain status information that are scheduled regularly or are available on an ad-hoc basis. Types of reports that are available is stored in the AUDIT-DB, which also stored information on the type of report, including data it contains to which actors the audit/reports/status information is distributed is stored in DISTR-DB.

Distribution Database 470, labeled DISTR-DB that specifies to which actors the audit/reports/status information, as described in the AUDIT-DB, is distributed. DISTR-DB describes when or under which conditions the reports, described in the AUDIT-DB, are produced, for instance if a report is produced with regular frequencies, or it is an ad-hoc report initiated by the user, or if the report is produced when a particular event arises. In addition, it also specifies to which actors a report should be provided when it is produced.

Authority Database 480, labeled AUTH-DB, contains information on the actors of the system, that is it provides information on auditors, suppliers, and regulators to which audits, reports, status information, and discrepancies are distributed. Thus, AUTH-DB provides information on actors and how to communicate information to them, while the DISTR-DB repository provides information on which type of information is distributed to which actors.

Rules Database 490, labeled RULES-DB, that describes information, editable by the system’s administrators, that is used to determine under which conditions and processes that information may be obtained on a product or its supply chain activities, such as production, packaging, shipments, reception of goods, or information such as quantities which may be suspect of causing discrepancies, that is inconsistencies in various pieces of information describing the product’s attributes and activities on it. The database is populated by extracting information from the REG-DB, VDC-DB, DC-DB, and SUST-DB and combining it with user supplied information. As new substances are created and their (verifiable) credentials are discovered by the system and stored in the VDC-DB or DC-DB, information is extracted from the REG-DB or from the traceability system, and stored in the RULES-DB. As regulations are discovered on the use of products that contain a regulated substance and are stored in the REG-DB, information about the rules is also extracted and stored in the RULES-DB. Similarly, information for the rules is also abstracted from information used to populate the REG-DB and SUST-DB.

In addition to the previously listed databases, the system includes methods for (i) methods to populate, amend, and manage the data in the internal repositories REG-DB, VDC-DB, DC-DB and SUST-DB, wherein these methods invoke and use the methods for inconsistencies checking; (ii) detecting inconsistencies in data stored in the internal DBs and inconsistencies of data between the internal repositories and information stored in the SC-i centers and R-i, i = 1, 2, …, RnR, regulatory repositories; as well as (iii) methods that enable search and retrieval of useful information stored by the STAT system in order to provide information for reports on the supply-chain status and detected inconsistencies, dashboards, and processing of data supplied by entities, product producers, when they provide information to the system on their activities on products in the supply chain.

### Methods to populate and amend the REG-DB, SDS-DB, and MAT-DB repositories.

The system obtains information from the regulations repositories and from the SC Center in the following ways:

When the system connects to the SC-i center or a regulations repository R-i for the first time, the system obtains information, and information on any of the products in the SUST-DB. For instance, when the system connects to a regulations DB, say R-i, for the first time, it searches R-i for all regulations related to any of the product information stored in SUST-DB: Information retrieved from R-i repository is stored in the REG-DB. When the system connects to the SC-i Center for the first time, the system retrieves from the SC-i all data or credentials on any of the products or their ingredients that are stored in the SUST-DB of the system.

The system keeps its REG-DB and the VDC-DB and DC-DB up-to-date using either a (i) pull or (ii) push approach.

Pull approach: The system periodically connects to the repository (regulatory or SC-Center) in order to find and retrieve any new or updated information (regulations or credentials).

Push approach: If the regulations repository or a SC-i Center publishes its amendments to its repository, then the system registers for such announcements and listens for the updates to be announced by the repository and stores them in its corresponding internal repositories.

Whenever a new regulations repository, say R-i, is connected to the system for the first time, the system obtains information on all regulations, which apply on any items stored in the SUST-DB, and stores them in the REG-DB.

Whenever the system receives information on a new product from a supply-chain entity E-i, the entity may also supply the system with a credential for that product. The system connects to the SC-i Center and checks for the credentials for that product. If the entity also supplied its credential(s) for the product to the system, then the system checks any credentials retrieved from the SC-i center and the credential submitted by the entity for consistency and if discrepancies are found, they are recorded in the DISCR-DB and to the entity and, if appropriate, to auditors. Other checks are also performed as described herein.

### Methods for Search of REG-DB

There are two types of methods performed by the system that use the REG-DB:

First, methods that provide for search and retrieval of regulations stored in the REG-DB. These methods are used to retrieve information from REG-DB about a particular product for a particular activity, such as transport or storage or a particular process in which the material is used. Thus, methods exist to find regulations for transport, storage, and use for a particular material or product (for instance, to provide a shipper with pertinent information on transport of a material or to a warehouse on its storage) and based on parameters of geographical region to which the regulation applies and date/time when the regulation was created.

Second, when an amendment to a regulation repository, such as R is detected, it is either because a new regulation is created or an existing regulation is amended. Assume that the new or amended regulation is W. The system invokes a method for checking inconsistencies for any product information recorded in the SUST-DB database that violates the regulation X (see FIG. 2). If inconsistencies are detected in information recorded in the SUST-DB and the regulation X, such inconsistencies are recorded in the DISCR-DB and appropriate alerts and reports are produced.

### Methods to Search VDC-DB and DC-DB

There are the following types of methods that search for information stored in the VDC-DB or DC-DB: (i) methods that obtain, from the supply chain entities, (verifiable) credentials that may be for new products/substances/materials and (verifiable) credentials that already exist in the VDC-DB and (ii) methods that search the VDC-DB for (verifiable) credentials based on the (verifiable) credentials index number, such as to find a (verifiable) credentials for a product, product component, or substance, having the product, product component or substanceID being X, where the product, product component, or substance ID is the unique product, product component, or substance index number assigned to the product, product component, or substance by the SC Center or the system; or (iii) or methods for search based on the properties of the (verifiable) credential, such as find all (verifiable) credentials that contain the substance with a substance ID being Y in concentration of more than Z% of volume.

Methods that use the VDC-DB or DC-DB which are described below, utilize methods for checking integrity of (verifiable) credentials More specifically, when a new or updated (verifiable) credential is obtained, either from the supply-chain entity or from a SC-i center or our system, for a product X, automated methods for checking integrity of information for the submitted (verifiable) credential is performed relative to the information stored in the VDC-DB or DC-DB on the product X and relative to the (verifiable) credentials for the ingredients of X from which X is composed. These checking methods are discussed under methods related to the DISCR-DB. Methods that use VDC-DB or DC-DB include:

Methods that obtain (verifiable) credentials, provided publicly by the supply-chain entities E1, E2, …, En_{E}, or regulators, or auditors and process and store them in the VDC-DB or DC-DB. The methods support cases discussed below. Whenever a new or updated (V)DC, say (V)DC-x for the product X, is provided by a supply-chain entity to the system, the system retrieves the corresponding the (V)DC for the product X from a SC-i center or (V)DC -DB and performs checking the two (verifiable) digital credentials for discrepancies. If discrepancies are found, they are stored in the DISCR-DB and appropriate alerts are raised as described later. The supply-chain entities report their (verifiable) digital credentials to the system in one of the following ways:

When the system is connected to supply-chain entity Ei for the first time, in which case all of its (verifiable) digital credentials are retrieved for any substances or materials for which the entity is the supplier.

The system connects to the entity Ei periodically to search for new (verifiable) digital credentials and for updates to existing (verifiable) digital credentials that, if found, are retrieved, processed and stored in the VDC-DB or DC-DB.

Connecting to the entity Ei to search for an (verifiable) digital credentials for any substance or material that satisfies certain conditions that (verifiable) digital credentials attributes must satisfy for retrieval. Examples include a search for an (verifiable) digital credentials given the (verifiable) digital credential(s) identifier(s) or search for any (verifiable) digital credential that contains a specific regulated material Y or for any regulated material listed in the product’s (verifiable) digital credentials. These methods are utilized by other methods, for instance, when checking for discrepancies for a new product being reported for which (verifiable) digital credentials have been submitted for materials/substances

Methods that provide for search and retrieval of (verifiable) digital credentials stored in the VDC-DB or DC-DB. These methods are used to retrieve information about a particular product for a particular activity, such as transport or storage or a particular process in which the material is used, in a particular geographical place. Thus, methods exist to find (verifiable) digital credentials for a product and reconcile if the product contains any regulated substance or material, and other information contained in (verifiable) digital credentials with the tracked production process, packaging, transport, storage, or use of the product.

When a new (verifiable) digital credential, say with an ID being W, or amendment (such as corrections) to an existing (verifiable) digital credential with an ID W, is detected in SC-i repository, the system method to manage the VDC-DB or DC-DB invokes a method for checking inconsistencies for any product information recorded in the SUST-DB database that refers to the amended (verifiable) digital credential with an ID X. If inconsistencies are detected in information recorded in the SUST-DB and the amended (verifiable) digital credential X, such inconsistencies are recorded in the DISCR-DB and appropriate alerts and reports are produced.

### Methods to Search SUST-DB

The SUST-DB contains information on the activities performed on their product by the supply-chain entities E-1, E-2, …, EnE. This information is obtained from the supply-chain entities by the system using either a pull or push approach. Information provided by a supply-chain entity on its activity on a product includes a product ID that the supply-chain entity uses to uniquely identify its product. This product ID may be unique across the supply chain, for instance if the chain is only for one big retailer, such as Walmart or Costco, that retailer may mandate that all its suppliers use one standard for a product IDs. However, in a general situation, this might not be the case. Consequently, the system assigns its unique IDs to a product and performs translation of the product ID, which is reported by the supplier of the product, into an ID used by the system, an ID that is unique across the supply chain. Individual supply-chain entities need not be aware of this and there are no implications on their internal systems that continue to use their own IDs.

Supply-chain entities include in their information, identified by their product ID and provided to the system, properties on the process used to produce the product, such as inputs to the production process, including any materials that are consumed fully or partially by the process, either disposed of as no longer usable or being used-up as a catalyst. Information includes properties of the product, such as content of ingredients used as input and in which concentration they are within the product, if applicable. Furthermore, information on any (verifiable) digital credentials that are applicable to the product is also provided either as a reference to an (verifiable) digital credential stored and managed by a SC-i center, or to an (verifiable) digital credential that can be obtained from the entity’s website or a repository, or an (verifiable) digital credential may be supplied directly with information. Also included is information on the product’s intended use. For instance, if a substance is a chemical with the intended use as a catalyst to produce the substance X, then the implication is that if X is used, for instance, as a catalyst for another substance, say Y, then such a use may no longer be safe.

Some supply-chain entities may provide information not only on regulated materials or products, but also on non-regulated products. For instance, an entity may produce a product that is supplied to different clients in different supply chains. As the clients may be located in different geographical regions, different regulations may apply requiring different types of information that needs to be provided to show that regulations are met. Instead of reporting different types of information pertaining to the different regulations that may be applicable to different supply chains, the entity may choose to amalgamate all information and report it to all supply chains. If a supply chain does not require some information that is provided to it, it may simply ignore it. Of course, this is possible only if the regulations are not contradictory to each other, such as one regulation stating that a substance X may not contain more than Z percent of substance Y, while another regulation for a different geographical region states that a substance X must contain more than W percent of substance Y, where W>Z.

Examples of information, which may be included by a supply-chain entity when providing the system with information on their activity on the product, are given below; however, the list is not exhaustive and other examples exist or may be created, perhaps as combinations of information shown in the examples. Examples of information on the process used for the production include:

Information on all inputs, including their identification and other properties, such as how much of an input item in appropriate units, such as quantity (number of units) or weight (e.g., for bulk materials).

For what purpose is the input, such as substance/material/product-item, used and how much is consumed by the production process or how much is considered to be a waste as it is no longer usable. For instance, the product may be an assembly part and that 2 units are required. Or an input is a chemical substance that is used as catalyst in the production process and all of it is used up as a process.

Information about a process may also be specified. For instance, an assembly may be used for products assembled from parts input into the process. Or information is that a well-known process is named for a production of the product, such as a substance.

Identification of any chemical substances, using their Service center SC-i identifiers, that are used in the production process, including solvents and catalysts.

Information on by-products produced by the process, including how much using appropriate units. For any by-product chemicals produced, their Service center SC-i identifiers are used.

Information on the output of the production process, that is, information on the product produced and any by-products that are produced. The product output or the production process by-products are described using appropriate units, such as weight, percentage, volume, or quantity.

Intended use(s) for the produced product may be listed. This information is required for products that are regulated substances. For instance, if the intended use of a chemical substance is to be an ingredient for producing X, that substance may not be safe if used as an ingredient to produce Y.

If the produced product or by-products contain ingredients that are regulated substances, then references to their (verifiable) digital credentials must be provided.

If the production process is secret or if the production process uses secret input ingredient(s), such secrets need to be identified, that is information that secret(s) exists needs to be provided, but not what the secret is.

### Methods to populate, amend and use DISCR-DB

FIG. 2 shows interactions between the methods used for population and management of the REG-DB, (V)DC-DB, and SUST-DB and the methods that perform inconsistency checking and populate and manage the DISCR-DB and methods for reporting and auditing functions. Methods for discrepancy checking and management of DISCR-DB include methods for automated checking of integrity of information, self-correction of erroneous information under certain conditions, and raising of alerts about information that is suspected of being incorrect, together with information on why alert was being raised, so that a human intervention may take steps to resolve the issue, if needed. The figure shows that the inconsistency checking is performed using rules stored in the RULES-DB, which may be either a simple storage providing methods to read and write rules, or it could be a database providing a more sophisticated search engine. The rules are cached for efficiency purposes. The rules provide information on which specific pieces of information should be checked together with providing threshold values that the discovered potential inconsistencies need to exceed before the they are reported.

For instance, consider a regulation that states that a percentage content of a regulated substance X, used as an ingredient must not be more than 2% with a threshold value of 0.1. Assume that a product Y was reported to have 2.05% percent content of the ingredient X. The RULES-DB contains a rule that expresses the regulation about the content, together with the threshold value of 0.1. When the rule is applied to the reported content of 2.05, inconsistency would not be raised as the reported value of 2.05% does not exceed the value of 2% plus the threshold value of 0.1.

The RULES-DB also contains parameters that express conditions that determine when checking for inconsistencies should be performed. For instance, the parameters may state that inconsistency checking should be performed whenever possible. Or they may state that inconsistency checking should be performed in a random fashion or with a certain frequency, or they may state that inconsistency should be performed only on certain reported activities on the supply chain products, such as apply consistency checking for transport and storage of the product X. Or it may be a combination of the above, that is parameters that indicate for which reported activities on which products should be applied and with which frequency. Thus, the rules are not hard-coded, but rather they are stored in RULES-DB in a text form and are modifiable as the need arises and as the regulations and standards change.

The methods for populating and managing the DISCR-DB thus also use methods to populate and manage the RULES-DB, and methods that facilitate search in the RULES-DB, if the search is not supported by the RULES-DB repository native search functions. For instance, search may be used to find rules applicable to a certain product, or that apply to transport of the product X. RULES-DB is populated by extracting information from the REG-DB, VDC-DB, DC-DB, and SUST-DB and user supplied information. As new substances are created and their SC sheets are discovered by the system and stored in the VDC-DB or DC-DB, information is extracted from the SC sheet and stored in the RULES-DB. As regulations are discovered on the use of products that contain a regulated substance and are stored in the REG-DB, information about the rules is also extracted and stored in the RULES-DB. Similarly, information for the rules is also abstracted from information used to populate the SUST-DB.

FIG. 2 also shows how it is determined to whom an inconsistency which has been discovered, or an audit performed should be reported. AUDIT-DB contains information on audits that need to be performed, that is specification of what type of an audit it is, under which conditions/events it should be performed, e.g., upon request by an auditor or stakeholder, with certain frequency (e.g., month-end), or when certain events occurring, such as certain inconsistency is detected. Which type of an audit it is includes information on which type of product/material/substance it should include, or for which supply-chain entities or the whole chain it applies. DISTR-DB species which of the audits, described in the AUDIT-DB, should be distributed to which of the stakeholders/auditors that are recorded in the AUTH-DB.

The following few examples illustrate the use of the methods for the DISCR-DB repository. These examples are not exhaustive.

Example – Checking for Inconsistencies between a Product (verifiable) digital credentials and the Reported Product Activity

Consider a product/material X that was just produced and is being reported to the system by the supply chain entity Ej. The system takes the information on the reported product, product component, material or substance X, its inputs, production processes description, outputs and by-products, and then it performs an evaluation to determine if information being reported on the production of X is consistent with its (V)DC that is retrieved from the (V)DC_DB. The evaluation to determine if the information on X is consistent with its (verifiable) digital credentials includes first finding any potential problems, discrepancies or inconsistencies.

To find potential problems between the (V)DC for the material X and information reported on the production of X, the system first finds the description of inputs and outputs to the production process of X and the description of the process itself. For each regulated substance/material, say Y, the system method first determines the SC identifier for X and then retrieves the (verifiable) digital credentials for X as it appears in the (V)DC-DB.

The system then checks the production description for X, in particular how much of Y is input into the process of X using appropriate units. It then also checks the production process description in terms of how much the production process either consumer or produces Y and calculates how much of Y is contained in X as an ingredient based on the production process description of X – call the calculated value Est(Y). This value is then compared to allowable content, using appropriate units, as specified in the (verifiable) digital credentials for Y, call it (V)DC(Y). If the Est(Y) value indicates that the content of Y in X is higher then the allowed (V)DC(Y), derived from (verifiable) digital credentials for Y, then a potential discrepancy is entered in into the DISCR-DB. Furthermore, RULES-DB is checked to determine if the found discrepancy is to be reported and, if so, the DISTR-DB is checked to whom the discrepancy should be reported, and the AUTH-DB is accessed to find the manner in which the authority should be informed.

Example: Checking for Inconsistencies between (verifiable) digital credentials for Product X and (verifiable) digital credentials of Its Ingredients

Consider an (verifiable) digital credential x for the product X as provided by the supply-chain entity Ei. The (verifiable) digital credential for the product, component, material, or substance X, labelled as (V)DC x, has a list of regulated substances that are used in the production of the X. A production process for X contains: (i) details on materials that are input to the process (which materials and how much or quantity in appropriate units); (ii) details on materials or products output by the process; and (iii) details on materials transformed by the process, that is, either consumed by the process (e.g., details on materials consumed as process catalysts) or produced by the process (e.g., details on regulated substance or material produced as waste). The system uses the methods for the DISCR-DB to check the consistency of information between the (verifiable) digital credential for the product X and the (verifiable) digital credentials for the substances/materials used to produce X, i.e., (verifiable) digital credentials or the components/ingredients of X. This is achieved by examining the production process of X and its inputs and outputs to search for discrepancies by checking that for each ingredient of X, the production process information on retainment of each ingredient and the total content of that ingredient in X:

For each substance or material (regulated or not), call it Y, that was input by the process to create X, the method is used to find potential problems between the (verifiable) digital credentials for the product X and the (verifiable) digital credentials for the materials input into the process to produce X.

First, determine the SC identifier for Y and then find the (verifiable) digital credentials for Y as it appears in the (V)DC-DB.

For each regulated material Zk, where Zk represents the SC identifier for the regulatory material contained in Y that is listed in the (verifiable) digital credentials for Y, determine the content of the material Zk in the material Y, label it Zk(Y) as it is reported in the (verifiable) digital credentials for the material Zk(Y) in the (V)DC-DB.

Sum up all Zk(Y) values over all Ys (i.e., over all inputs Y for the process producing the material X as it is recorded (V)DC-DB). Each Zk(Y) represents the content of the regulated material Zk in the material Y that is used as input to the process of producing X.

The sum of all Zk(Y), over all materials Y, should be within a range (W-Rlow, W+Rhigh), where W is the content of Y as reported by the (verifiable) digital credentials, in the (V)DC-DB, for the material Y and Rlow and Rhigh define a range of values for Y as a function of W, Rlow, and Rhigh. The Rlow and Rhigh ranges are set as threshold values for Y and are stored in the CHECK-VDC module. If the sum of all Zk(Y), over all materials Y used to produce X as reported in the (V)DC-DB, is not within the range (W-Rlow, W+Rhigh), then an alert is raised with an explanation that the sum of the content of the regulated material X, over all inputs to Y, is greater than the content of Y as reported in the (verifiable) digital credentials for the material X. This discrepancy is reported in an alert for further investigation as, unless the process to produce X consumes the material Y or creates the material Y in X as a by-product of the production process of X, then there is a discrepancy that should be investigated and corrected.

The above process may be applied recursively, that is that each input to product Y (which is input to X) is also checked recursively in the same manner as it was done for the inputs to the product X. The level of recursion is specified by the user, while the default is no recursion. A person of ordinary skill in the art would understand that the above process may be applied repeatedly or recursively.

It should be noted that this method checks that an (verifiable) digital credential for an item X is consistent with (verifiable) digital credentials of items listed, on the (verifiable) digital credentials for X, as substances/materials that X contains in its composition.

Whenever the system retrieves a (verifiable) digital credential, from a supply-chain entity, that is (i) not in the (V)DC-DB or (ii) it is in the (V)DC-DB, but the (verifiable) digital credential retrieved from the entity is an update to of the one stored in the (V)DC-DB (as determined by respective dates of when they come to effect), then this method is used to ensure that new or updated (verifiable) digital credential retrieved from the entity is consistent with the information of (verifiable) digital credentials for materials used in its production.

### Methods for Search, Audits and Reporting

There is also provided methods for searching in repositories to produce reports on a regular basis. It thus has facilities to enable the user to search through repositories to produce ad-hoc or regular reports. Searches and report specifications are parameterized and stored for repeated use. Parameterizing reports means that if the user creates a report for a particular product, say X for the day Y, the search query is stored in a parameterized form that can be retrieved, but instead of the product X for the day Y, the values for X and Y are supplied by the user each time the query is issued. However, the user may also create, from parameterized queries, regularly produced reports by specifying the parameters and frequency with which it should be produced, e.g., once a week, randomly, or when a particular event(s) arises. Specialized reports requested by auditors are also supported. However, the search and reporting methods are also used for monitoring purposes by providing information displayed in dashboards and reports on the “health” of the system.

Methods are provided that support search for information that satisfies properties specified by a user. The user can search for information that satisfies certain properties to answer general purpose queries, such as:

For a substance or material that is identified by the user, find the list of materials and products that were used by the process to produce the substance or material and then further restricting the list by specifying additional constraints, such range of dates of production or geographical region.

Produce a list of all products that contain a user-input substance and for each product list locations to which the product has been shipped internally (within a company) or externally.

For any new downstream use or application of a product, notify all upstream trade secret holders of chemical substance that were used, as inputs into the production processes of that product, about the new use of that product.

Produce a list of facilities for a specific geographical location or region and obtain the facilities’ classification according to the North American Industry Classification System (NAICS).

For filtered products, e.g., products that are imported or are imported from a specific country or a region, find the list of their uses, such as production of toys.

For a specific substance, find a list of the substance functions and applications/uses.

Produce a list of CASes for products stored with an option to also show how much of each regulated product is stored: in a facility, wherein the facility is identified by the user; stored in any facility of a company identified by the user; or every facility of the entity, i.e., for each facility, CASes are listed for all regulated substances (identified by SC) and, if applicable, including thresholds for safe content of the regulated ingredient in a product, wherein the content is expressed in one of the many units for that purpose, such as maximum percentage content in volume of liquid, or maximum grams per kilogram.

For a user-supplied product-ID, find its list of inputs in a recursive fashion (list of inputs for a product X, and for each input find its inputs, and apply repeatedly; thus finding all inputs that go into the production of X, including inputs for its parts and substances). As an example, this functionality can be used to show the product customer (purchasing the product) all inputs used to produce the product (and then use further STAT functionality to show that the inputs satisfy all regulations applicable to them).

For a user-supplied product-ID, find its list of outputs in a recursive fashion (list of outputs for a product X, and for each output, find its outputs and apply repeatedly; thus finding all products in which X served as an input to those products’ productions. As an example, this functionality can be used for a recall if the product X was found defective.

For a substance identified by the user: find all facilities carrying the substance and how much is being stored; find how much of the substance is stored in a user-specified facility or all facilities of a user-specified company.

Find all uses of a substance, specified by a user, as used by downstream entities.

The system and method is thus capable of performing one or more of the following processes:

Population and management of information stored in the system repositories that contain information that pertain to a product’s sustainability credentials, such as and not limited to digital supply chain traces, supply chain actor permits and registrations, multi-jurisdictional recyclability symbols.

Checking the consistency of the information contained in regulations and on the information provided by the supply-chain entities to the system on the activities with the products. Inconsistencies are recorded in the DISCR-DB and are reported to the appropriate supply-chain entities and auditors. This process may further comprise searching for compromised credentials or other specific credentials.

Using the information for reporting purposes and for identifying discrepancies between information reported by the supplier-chain entities to the system and information contained in the regulations repositories or SC-i center.

Methods for reporting scheduled and ad-hoc audits and reports and provision of information for dashboards to show the status of the system.

Methods for downloading the data stored in the repositories into an ARCHIVE repository that is used for various purposes, such as for recovery information or for audit of historical information or in AI analysis.

Methods for generating process verifiable digital credentials with transparency of their data verification processes, and/or generating verifiable credentials, and/or aggregated digital credentials.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the Patent and Trademark Office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A method for creating a process verifiable digital credential, comprising:
processing a record comprising an input, a transformation, and an output;
receiving an input digital credential for the input;
verifying the input digital credential;
creating a verifiable input digital credential by cryptographically signing the input digital credential;
creating a process verifiable output digital credential containing the verifiable input digital credential by cryptographically signing the process verifiable output digital credential;
immutably recording the verifiable input digital credential and the process verifiable output digital credential to the record.

2. The method of claim 1, further comprising:
receiving an output digital credential for the output;
verifying the output digital credential;
creating a verifiable output digital credential by cryptographically signing the output digital credential;
creating a process verifiable output digital credential containing the verifiable input digital credential and the verifiable output digital credential by cryptographically signing the process verifiable output digital credential;
immutably recording the verifiable input digital credential, the verifiable output digital credential, and, the process verifiable output digital credential to the record.

3. The method of claim 1, further comprising:
receiving a transformation digital credential for the transformation;
verifying the transformation digital credential;
creating a verifiable transformation digital credential by cryptographically signing the transformation digital credential;
creating a process verifiable output digital credential containing the verifiable input digital credential, the verifiable output digital credential, and, the verifiable transformation digital credential by cryptographically signing the process verifiable output digital credential;
immutably recording the verifiable input digital credential, the verifiable output digital credential, the verifiable transformation digital credential, and, the process verifiable output digital credential to the record.

4. The method of claim 1, wherein:
the verifying of the input digital credential, comprises:
validating an input attribute of the input with a stored input attribute in the input digital credential;
if the validating fails, then reporting an input discrepancy.

5. The method of claim 2, wherein:
the verifying of the output digital credential, comprises:
validating an output attribute of the output with a stored output attribute of the output digital credential; and
if the validating fails, then reporting an output discrepancy.

6. The method of claim 3, wherein:
the verifying of the transformation digital credential, comprises:
validating a transformation attribute of the transformation with a stored transformation attribute of the transformation digital credential.
if the validating fails, then reporting a transformation discrepancy.

7. The method of claim 1, wherein:
the verifying of the digital credential, comprises:
checking if the digital credential was previously verified;
if the digital credential was previously verified, then returning that the digital credential is a verifiable digital credential.

8. The method of claim 4, wherein:
the input attribute is an input physical characteristic of the input;
the output attribute is an output physical characteristic of the output; and/or
the transform attribute is a physical transformation of the transformation.

9. The method of claim 4, wherein:
the input attribute is an input identity of an input party related to the input;
the output attribute is an output identify of an output party related to the output; and/or
the transformation attribute is a transformation identity of a transformation party related to the transformation.

10. The method of claim 4, wherein:
the input attribute is an input permission for the input;
the output attribute is an output permission for the output; and/or
the transform attribute is a transform permission for the transformation.

11. The method of claim 4, wherein:
the attribute comprises multiple attributes of physical characteristic, identity, and/or permission for each of the input, the output, and/or the transformation for the record.

12. The method of claim 4, further comprising:
the validating of the attribute comprises:
sending the input digital credential, the output digital credential, or the transform digital credential to an issuer of the digital credential or a verifier for verifying the digital credential;
receiving a valid digital credential response or an invalid digital credential response from the verifier;
if the valid digital credential response is received from the verifier, then validating the attribute.

13. The method of claim 1, further comprising:
tracing the record by using the process verifiable output digital credential, the tracing comprising:
extracting from the process verifiable output digital credential the verifiable digital credentials;
determining if the verifiable digital credentials match the input, the output, and/or, the transformation;
if the verifiable digital credentials do not match, then returning that the verifiable digital credentials do not match;
if the verifiable digital credentials do match, the returning that the verifiable credentials do match.

14. The method of claim 13, further comprising:
repeating the tracing the record by tracing a linked record, the linked record being related to the input, the output, and/or the transformation with a linked process verifiable output digital credential.

15. The method of claim 1, further comprising:
searching the record for a search object by the tracing step further comprising:
determining if the search object matches or is contained by the record or the process verifiable output digital credential;
if the search object matches, then returning a search match;
if the search object does not match, then continuing the searching for the linked record;
wherein, the search object is one or more of the input, the output, the transformation, the party, the digital credential, or the attribute.

16. The method of claim 1, further comprising:
sending the process verifiable output digital credential to the verifier for verification and cryptographic signing of the process verifiable output digital credential by the verifier.

17. The method of claim 1, further comprising:
the verifying of the input/output/transformation digital credential determines that the input/output/transformation digital credential is non-verifiable;
the step of creating a process-verifiable output digital credential containing the verifiable input/output/transformation digital credential by cryptographically signing the process verifiable output digital credential, further comprising:
creating the process verifiable output digital credential containing the non-verifiable input/output/transformation credential by cryptographically signing the process verifiable output digital credential, and, marking the process verifiable output digital credential as containing a non-verifiable credential; and/or
creating the process verifiable output digital credential containing the non-verifiable input/output/transformation credential and the verifiable input/output/transformation digital credential by cryptographically signing the process verifiable output digital credential, and, marking the process verifiable output digital credential as containing a non-verifiable credential.

18. The method of claim 1, wherein, by cryptographically signing comprises by hashing and cryptographically signing.

19. A computer system for implementing the method of claim 1.

20. A computer system as described in the description for implementing the method of claim 1.
